(19) United States
(12) Patent Application Publication
(10) Pub. No.: US 2014/0101683 A1
(43) Pub. Date: Apr. 10, 2014

(54) METHODS AND APPARATUS FOR DETECTING A TELEVISION CHANNEL CHANGE EVENT

(71) Applicant: SAMSUNG ELECTRONICS CO., LTD., Gyeonggi-do (KR)

(72) Inventors: Yuri ARSHAVSKI, Netanya (IL); Dan MAKARANZ, Beer Yaakov (IL); Yaniv SHAKED, Binyamina (IL)

(73) Assignee: SAMSUNG ELECTRONICS CO., LTD., Gyeonggi-do (KR)

(21) Appl. No.: 13/648,481

(22) Filed: Oct. 10, 2012

(51) Int. Cl. H04H 60/31

(52) U.S. Cl. 725/14

(57) ABSTRACT

A method for detecting an event indicative of a change of TV channel by a viewer comprises analyzing one or more video frames displayed on the TV screen to identify a change which is associated with a TV channel change.

### FIELD OF THE INVENTION

The present invention relates to the detection of events related to a situation when a TV viewer changes the channel currently being viewed.

### BACKGROUND OF THE INVENTION

There is a growing need for TV content providers to improve both the content and the advertisements served to television viewers. In order to improve, however, it is necessary to understand the viewer's preference, and particularly what the viewer wishes to see and when he wishes to see it. Then effective advertisements and other content can be served at a time when the viewer is the most receptive for it. A useful tool for this purpose is the detection of TV channel change, which allows measuring an audience viewing habits.

The most commonly attempted solution in the art uses the set-top box (STB) digital and analog information to detect channel tune events and channel attributes. Examples of such prior art methods include using the Direct Channel Change Table (DCCT) (US 2007/004120, the Program Association Table (PAT), the Program Map Table (PMT) or the Conditional Access Table (CAT) (U.S. Pat. No. 7,086,076). WO 2005/057322 relates to On Screen Channel Change Detection (OSCCD) and detects and analyses a digit images in the frame sequences.

In spite of many attempts found in the art to address the issue of channel change detection, the art has so far failed to provide a simple and effective method, which is not dependent on external factors. Some of the known solutions make use of the internal STB digital information that is not always available. Others detect digits on the screen or the channel logo, which is relevant only to a small part of channel tune event cases, since the channel number is not always present on the screen, and furthermore the channel logo does not appear constantly and may disappear (for example during advertisements). The prior art solutions become even less feasible for transparent or animated channel numbers or logos.

It is an object of the present invention to provide a robust channel change detection, which is independent of TV source and of channel specific characteristic, such as logo or channel number.

It is a further object of the invention to provide a generic solution that makes use of channel change co-events (i.e. other events that occur during the channel change) to create a combination of features that indicates that an event of channel change is taking place or has occurred.

It is yet another embodiment of the invention to provide apparatus that is capable of detecting channel change events.

Other objects and advantages of the invention will become apparent as the description proceeds.

### SUMMARY OF THE INVENTION

The invention relates to a method for detecting an event indicative of a change of TV channel by a viewer, comprising analyzing one or more video frames displayed on the TV screen to identify a change which is associated with a TV channel change.

According to an embodiment of the invention the one or more frames are analyzed to identify a change selected from Null Frame, a Scene Change, the apparition of an EPG OSD, and a change in a Constant Region.

In another embodiment of the invention each change is assigned a weight indicative of the probability that it in fact represents a channel change. If it is desired to detect all channel change events, false alarms (false detection of channel change) are inevitable. Therefore, sometimes a channel change will be detected and reported even when no channel change has taken place. Since other mechanisms may check the channel (for example using channel logo recognition) and since the tune detection serves as a trigger for other operations (for example, for popping up a commercial on the screen), false alarm events may cause some unnecessary (but harmless) operation.

In one embodiment of the invention two or more identified changes are detected, to increase the probability that a TV channel change has occurred.

The invention also encompasses apparatus for detecting an event indicative of a change of TV channel by a viewer, comprising circuitry suitable to analyze one or more video frames displayed on the TV screen, to identify a change which is associated with a TV channel change.

A TV set which comprises apparatus according to the invention also forms a part of the present invention.

### BRIEF DESCRIPTION OF THE DRAWINGS

In the drawings:

FIG. 1 schematically illustrates in block diagram form an apparatus according to one embodiment of the invention;

FIG. 2 is a schematic illustration of a decision module according to one embodiment of the invention;

FIG. 3 (A through D) illustrates a change of channel event; and

FIG. 4 illustrates changes during the viewing of a TV show, which do not result in a channel change determination.

### DETAILED DESCRIPTION OF THE INVENTION

The source of the TV signal that reaches a TV set may be a set-top box (digital or analog), a streamer, a hotel cable network, a computer, etc. Therefore, for an efficient system like the one herein described, the channel tune event detection should be independent of TV source. According to the invention the event representing a change of channel is detected by the TV itself. TV sets operate according to various standards, such as the Phase Alternating Line (PAL)/National Television Standards Committee (NTCS)/Systeme Electronique pour Couleur avec Memoire (SECAM) standard, a standard developed by the Advanced Television System Committee (ATSC), such as high definition television (HDTV), a standard developed by the Digital Video Broadcasting (DVB) Project, or may be a multimedia computer system, etc. As will be apparent to the skilled person, it is desirable for a TV set to support all such standards or at least those which are applicable to the geographic area where the TV set is to be operated.

According to the present invention detection of channel change is performed by using a combination of one or more features that are typical of the channel change event. Since the channel change event may last approximately from one to few seconds, according to an embodiment of the invention one or more video frames are used to detect channel change events. An illustrative and non-exhaustive list of channel change detection features may include one or more of the above:

Null Frame (NF): Most STBs generate a black frame during the time of channel change, typically referred to as “null frame”. In one embodiment of the invention a null frame detector is provided to detect such null frame.

Scene Change: When a channel is changed, in many cases the old and new channel content parameters (such as SNR, white balance, illumination, etc) are different, because the scene showed is different. According to an embodiment of the invention a scene change detector is provided to identify such changes.

EPG OSD: EPG OSD (Electronic Program Guide On-Screen Display) is a specific STB computer graphic interface that appears upon channel change and provides the current/new channel information. According to an embodiment of the invention an OSD detector is provided to detect the appearance of such EPG. According to another embodiment of the invention, since the OSD topology may vary depending on the content provider, an OSD topology analyzer is also provided.

Constant regions: In one embodiment of the invention a constant region detector is provided, to detect constant areas in the scene that is viewed on the TV screen. A change of the constant region may hint at a channel change. A “constant region” may be, for example, the channel logo. A consistent channel logo may hint that a channel has not changed, while a change of logo may indicate that the channel has changed.

Decision Modules: According to an embodiment of the invention, a variety of modules can be provided, as will be further detailed below, which make use of one or more of the aforementioned features of the image shown on the screen, to detect channel tune events.

Illustrative suitable modules include, e.g.:
Preprocess
   Margins Crop—crop black margins from images (The so-called “Pillar”).
Frame Analysis
   Null Frame Detector
   Scene Change Detector
   OSD Detector
   OSD Topology Analyzer—calculate OSD positioning in frame
   Decision Module
   Use Frame analysis data to provide tune detection result by applying logic to the detected features to make a decision.

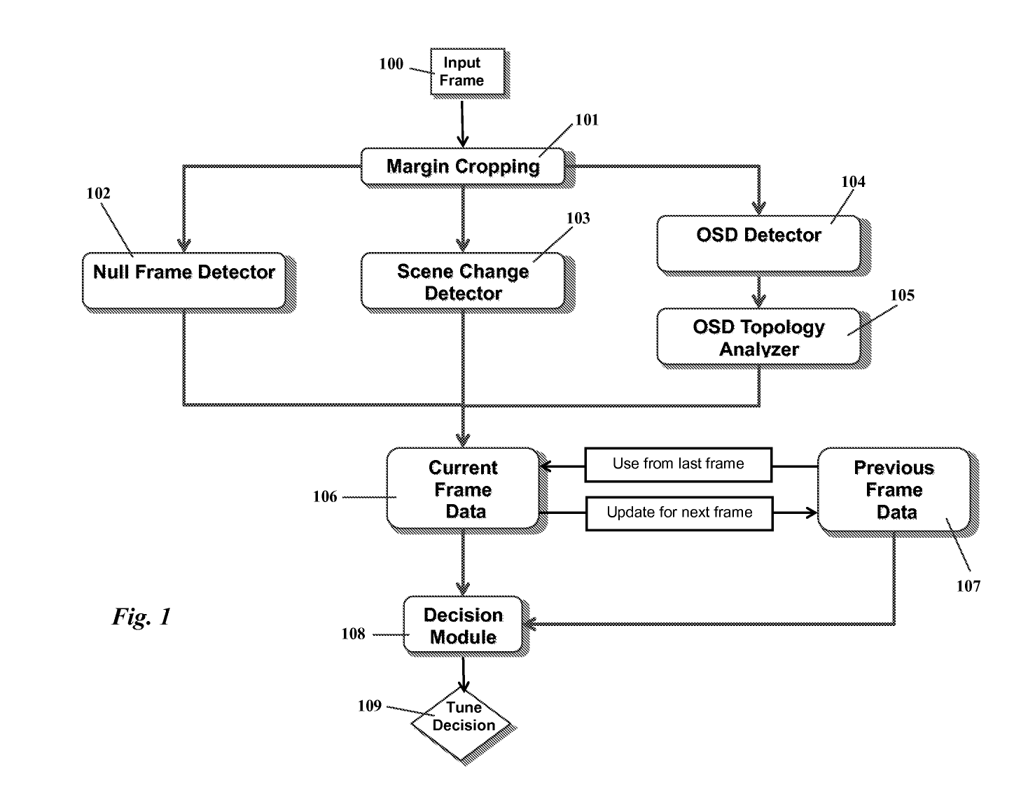

FIG. 1 schematically is a block diagram of the operation of one embodiment of the invention. A frame 100 grabbed from the TV set is input to a plurality of detectors, which may in different embodiments of the invention include more or less detectors, or different ones from those shown in the illustrative example of FIG. 1.

The margins of the frame are cropped by margin cropper 101, if needed because the content is smaller than the screen size, to remove black margins, and the resulting cropped frame is fed to Null Frame detector 102, to Scene Change detector 103 and to OSD detector 104, as previously explained. From OSD detector 104 the frame can further be fed to OSD Topology Analyzer 105. The result of all the above analyses is a set of data identified as Current Frame Data 106, which, either alone or together with Previous Frame Data 107, is fed to Decision Module 108. Current Frame Data 106 and Previous Frame Data 107 may also be used for making the channel change decision and the current data is saved to use as previous data of next frame. Thus, the decision module uses features of the current and of previous frames to make the decision that a channel has changed. The final result is the Tune Decision 109, generated by the Decision Module 108, which decides whether a change of channel has taken place.

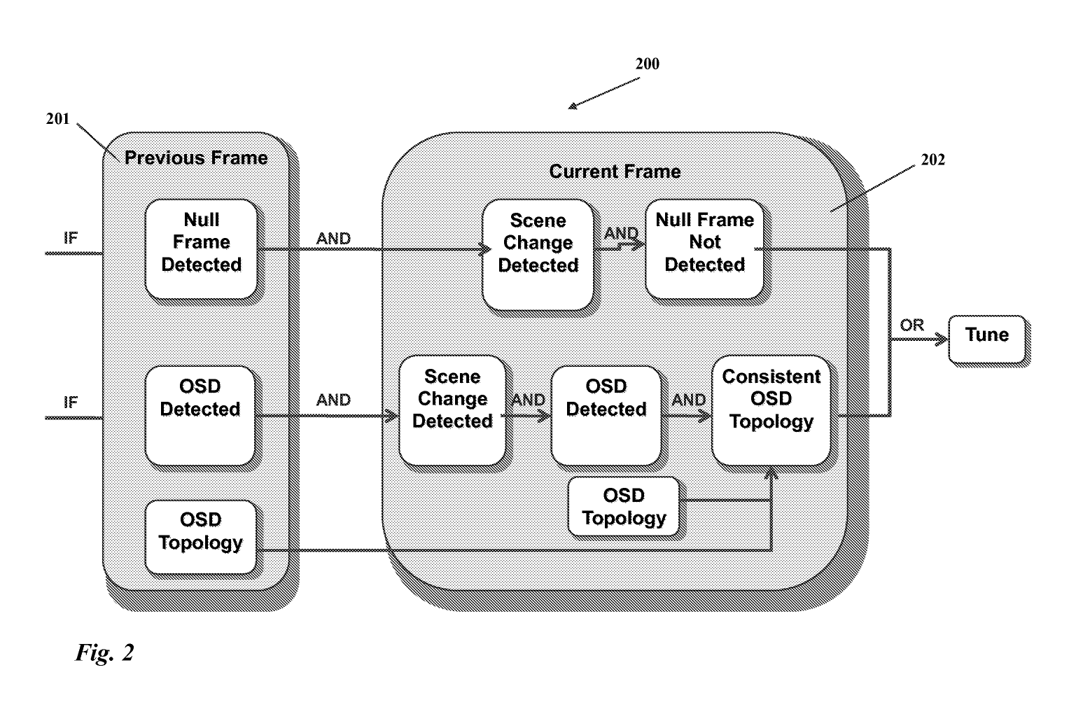

FIG. 2 shows an illustrative process taking place in the Decision Module, as explained above. The figure is self-explanatory and shows, in this case, a process 200 which uses a Previous Frame 201 and a Current Frame 203, to carry out the comparison and to combine the results so as to decide whether a channel change event has taken place.

### Example

### Channel Change Event

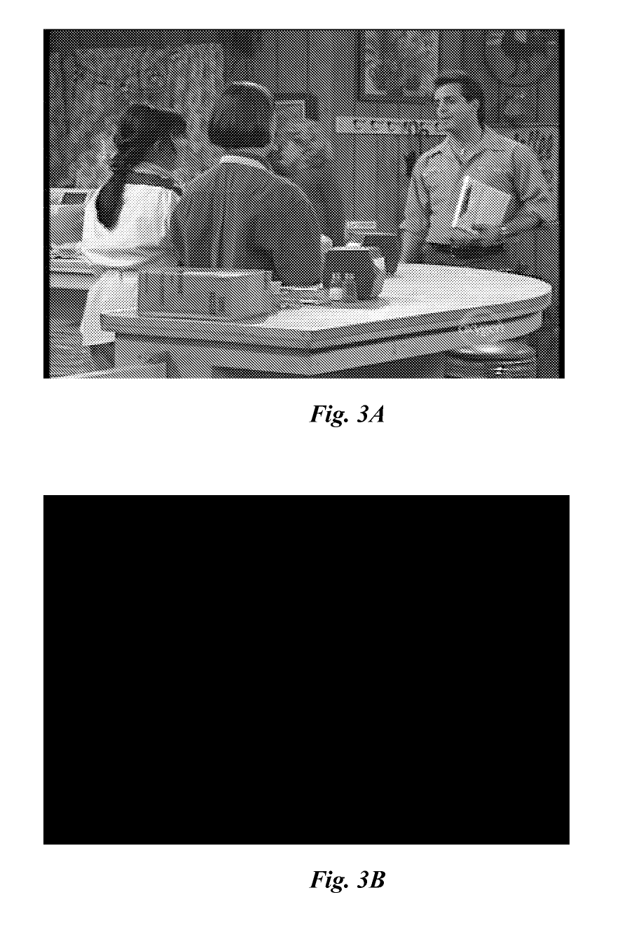

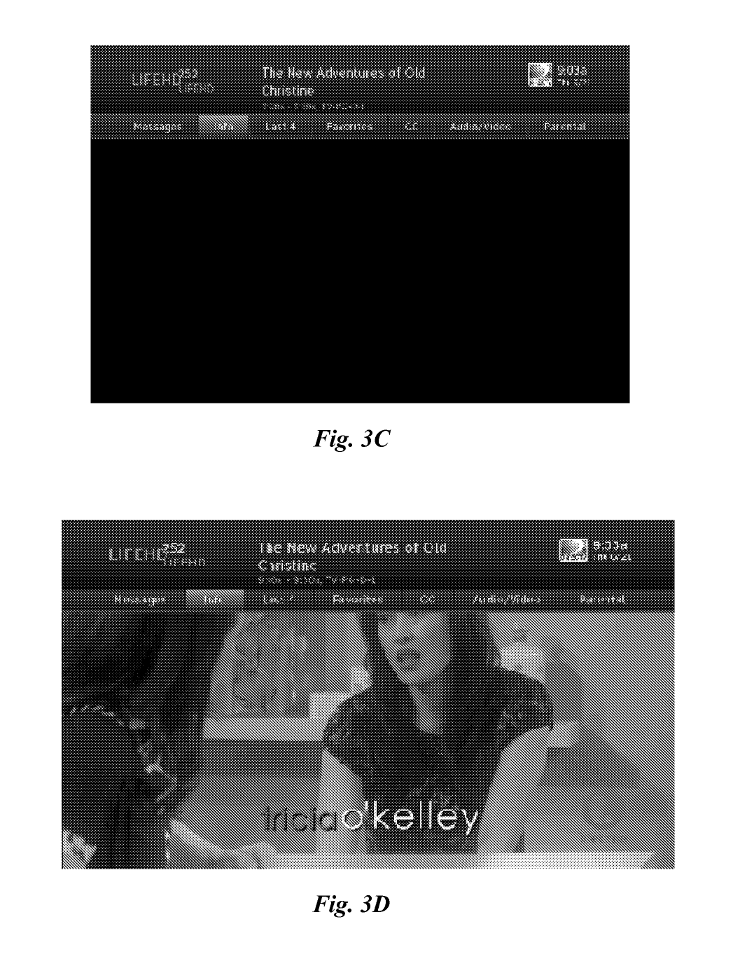

FIG. 3 illustrates a sequence of frames during which a channel is changed Frame 1 (FIG. 3A): is a frame from an arbitrary channel that a viewer may be watching.

Frame 2 (FIG. 3B): The user switches channel using the remote and a null frame appears. Null frames may appear during one or more frames or not to appear at all, depending on the specific STB (set top box).

Frame 3 (FIG. 3C): OSD EPG appears. It may appear for one or more frames, depending on the specific STB.

Frame 4 (FIG. 3D): A new (different) channel appears. The channel has changed and this is a “Tune” event.

### Example 2

### Constant Region

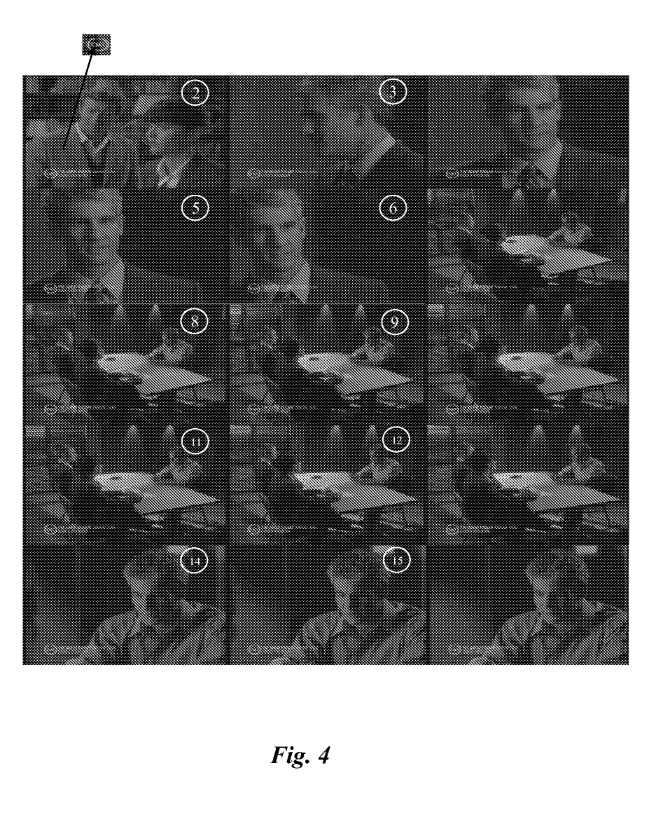

The sequence of frame of FIG. 4 is taken from a movie sequence captured from a STB. The channel logo appears at the bottom left area in yellow (TNT—but shown in white in the figure) during the entire sequence, serving as a constant region that indicates that no channel change has occurred, in spite of the fact that the scene changes in frames 1->2,5->6,12->13).

All the above description of preferred embodiments has been provided for the purpose of illustration and is not intended to limit the invention in any way. The invention provides channel tune event detection for all known TV video stream configurations. The used features allow the detection of channel tune events for different set-top boxes (digital, analog, generated and not generated Null Frame in channel tune process, all resolutions of stream (included HDTV). As will be apparent to the skilled person, many variations of the examples given above can be performed, using different on-screen features and events, all without exceeding the scope of the invention.

1. A method for detecting an event indicative of a change of TV channel by a viewer, comprising the steps of:
a) comparing previous and current video frames displayed on the TV screen to identify a change which is associated with a TV channel change; and
b) identifying a TV channel change event by detecting appearance of a null frame in said previous frame but not in said current frame.

2. The method according to claim 1, wherein a TV channel change event is identified by also detecting a change selected from the group consisting of a Scene Change, the apparition of an Electronic Program Guide On-Screen (EPG OSD), and a change in a Constant Region.

3. The method according to claim 2, wherein each change is assigned a weight indicative of the probability that it in fact represents a channel change.

4. The method according to claim 3, wherein two or more identified changes are detected, to increase the probability that a TV channel change has occurred.

5. Apparatus for detecting an event indicative of a change of TV channel by a viewer, comprising circuitry defining a null frame detector for detecting appearance of a null frame in a previous frame but not in a current video frame displayed on the TV screen, to identify a change which is associated with a TV channel change.

6. A TV set which comprises the apparatus according to claim 5.

7. The method according to claim 1, wherein the TV channel change event is also identified by detecting a change in a scene from the previous frame to the current frame.

8. The method according to claim 1, wherein margins of the previous and current frames are cropped to remove black margins before the previous and current frames are compared.
